(19) United States
(12) Patent Application Publication
(10) Pub. No.: US 2023/0100409 A1
(43) Pub. Date: Mar. 30, 2023

(54) UNIFORM DISTRIBUTION OF PERIPHERAL POWER IN ASIC PLATFORMS

(71) Applicant: ATI Technologies ULC, Markham (CA)

(72) Inventors: Danial Yahyazadeh, Markham (CA); Philippe Blanchard, Markham (CA)

(73) Assignee: ATI Technologies ULC, Markham (CA)

(21) Appl. No.: 17/490,964

(22) Filed: Sep. 30, 2021

(51) Int. Cl. G06F 1/26; G06F 13/38; G06F 13/40; G06T 1/20; H02M 1/00

(52) U.S. Cl. CPC G06F 1/26; G06F 13/385; G06F 13/4068; G06T 1/20; H02M 1/0025; H02M 1/0006

(57) ABSTRACT

A power supply circuit is provided for supplying power from multiple peripheral power supplies to a data processor. The power supply circuit includes a power bus, a plurality of load voltage converters each including an input coupled to the power bus and an output coupled to a respective one of multiple subsystems of the data processor, a plurality of input voltage converters each including an input for coupling to a respective one of multiple peripheral power supply voltages and an output coupled to the power bus, and a feedback control circuit having an input coupled to the power bus and a plurality of outputs coupled to respective ones of the input voltage converters for controlling a current draw of the respective input voltage converter.

### BACKGROUND

Modern computer systems often include a peripheral bus onto which peripheral processors are connected for performing functions such as graphics processing, math processing, artificial intelligence computations, or other types of processing. A graphics card is a common example of a peripheral processor. Such peripheral processors require a stable, low noise power supply to function well.

As the processing capability demanded from peripheral processors increases, the difficulty of providing stable power increases. Power is supplied to peripheral processors over power supply rails of a peripheral power bus. When a peripheral processor's power requirements exceed the power deliverable over the peripheral power bus, system designers include external voltage supply inputs for the peripheral processor by which it can receive additional power, which are connected to an external power supply. Various subsystems on peripheral processors also use different amounts of power and require different voltages.

One difficulty in providing power to peripheral processors is that the power capacity of peripheral bus power supply rails and the external voltage supplies do not match the power requirements of the various subsystems on a peripheral processor. This mismatch is because the power available over the peripheral bus is typically limited, and while external power supplies may be selected to better match the demands, there is such a wide variety of peripheral processors, deployed in differing combinations, that an external power supply exactly matching the requirements for a peripheral processor may not be commercially available. Furthermore, peripheral processors such as graphics cards are updated frequently, and their power supply requirements often change with each new generation. This mismatch of power supply capacity to the peripheral processor's requirements results in increased expense in redesigning the power supply circuit of the peripheral processor and inefficiency resulting from unused power supply capacity.

### BRIEF DESCRIPTION OF THE DRAWINGS

FIG. 1 illustrates in block diagram form a data processing system having a peripheral bus connecting peripheral data processors to a host processing system;

FIG. 2 illustrates in block diagram form a peripheral data processor including a power supply circuit for handling power from multiple external voltage sources according to some embodiments;

FIG. 3 shows in circuit diagram form a power supply circuit for supplying power from multiple peripheral power supplies to a peripheral data processor according to some embodiments;

FIG. 4 illustrates in mixed block diagram and circuit diagram form a power supply circuit for a peripheral data processor according to some embodiments; and

FIG. 5 shows a flow diagram of a process for providing power to multiple subsystems of a peripheral data processor according to some embodiments.

In the following description, the use of the same reference numerals in different drawings indicates similar or identical items. Unless otherwise noted, the word “coupled” and its associated verb forms include both direct connection and indirect electrical connection by means known in the art, and unless otherwise noted any description of direct connection implies alternate embodiments using suitable forms of indirect electrical connection as well.

### DETAILED DESCRIPTION OF ILLUSTRATIVE EMBODIMENTS

A power supply circuit is provided for supplying power from multiple peripheral power supplies to a data processor. The power supply circuit includes a power bus, a plurality of load voltage converters each including an input coupled to the power bus and an output coupled to a respective one of multiple subsystems of the data processor, a plurality of input voltage converters each including an input for coupling to a respective one of multiple peripheral power supply voltages and an output coupled to the power bus, and a feedback control circuit having an input coupled to the power bus and a plurality of outputs coupled to respective ones of the input voltage converters for controlling a current draw of the respective input voltage converter.

A method providing power to multiple subsystems of a data processor includes receiving a plurality of peripheral power supply voltages. The peripheral power supply voltages are converted to a common voltage and coupling power from said converted peripheral power supply voltages onto a power bus. The common voltage from the power bus is converted to a plurality of load supply voltages and supplying said load supply voltages to respective subsystems of the computing module. Responsive to monitoring the common voltage on the power bus, the method includes controlling current drawn from each of the peripheral power supply voltages.

A computing system includes a peripheral bus, a secondary power supply, a data processor, and a power supply circuit. The peripheral bus carries communication signals and first and second peripheral power supply voltages. The secondary power supply provides a third peripheral power supply voltage. The data processor is coupled to the peripheral bus and the secondary power supply, and includes multiple subsystems and a power supply circuit. The power supply circuit includes a power bus, a plurality of load voltage converters, a plurality of input voltage converters, and a feedback control circuit. The plurality of load voltage converters each include an input coupled to the power bus and an output coupled to a respective one of multiple subsystems. The plurality of input voltage converters each include an input for coupling to a respective one of the peripheral power supply voltages and an output coupled to the power bus. The feedback control circuit includes an input coupled to the power bus and a plurality of outputs coupled to respective ones of the input voltage converters and controlling a current draw of the respective input voltage converter.

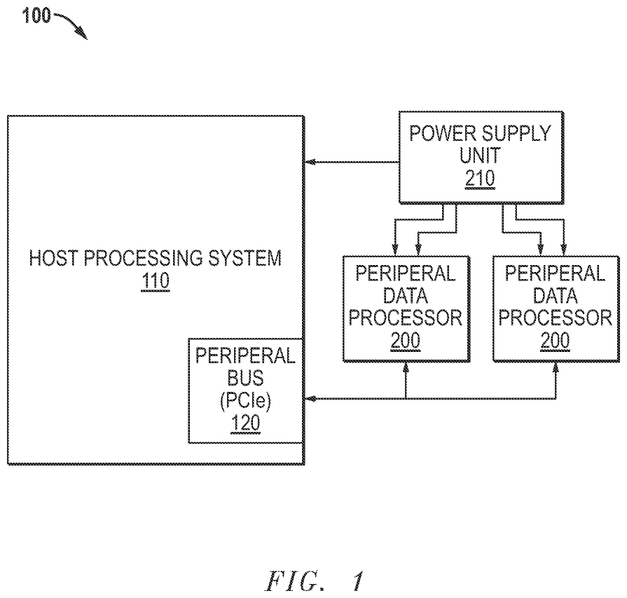

FIG. 1 illustrates in block diagram form a data processing system 100 including a peripheral bus connecting peripheral data processors to a host processing system. Data processing system 100 includes a host processing system 110, a peripheral bus controller 120, a power supply unit 210, and two peripheral data processors 200.

A suitable system for host processing system 110 is a computer, a server, or another type of computing system with a central processing unit (CPU), a graphics processing unit (GPU), or a combination of computing cores embodied in an Accelerated Processing Unit (APU) system. As such, host processing system 110 generally includes a one or more processor cores, a non-volatile memory, and a volatile memory system such as a dynamic random access memory (DRAM) (not shown). Host processing system 110 includes a peripheral bus controller 120, such as a peripheral component interconnect express (PCIe) interface controller for connecting to peripheral components of various types.

Each peripheral data processor 200 is bidirectionally connected to peripheral bus controller 120. Peripheral data processors 200 may be graphics cards or some other form of APU system such as math processors or artificial intelligence processors, for example.

Power supply unit 210 is a chassis or system power supply providing multiple supply voltages for host processing system 110 and peripheral data processors 200. As shown, power supply unit 210 is connected to host processing system 110 to provide at least one supply voltage for the host processing system. Power supply unit 210 is also connected to each of peripheral data processors 200 with multiple connections providing multiple peripheral supply voltages. For example, in an embodiment using a PCIe bus standard, power supply unit 210 may provide two separate 12V external voltage supplies to each of peripheral data processors 200.

Each peripheral data processor 200 also receives one or more supply voltages over peripheral bus 120. For example, in embodiments employing PCIe, a 12V bus supply voltage and a 3.3V bus supply voltage may be provided.

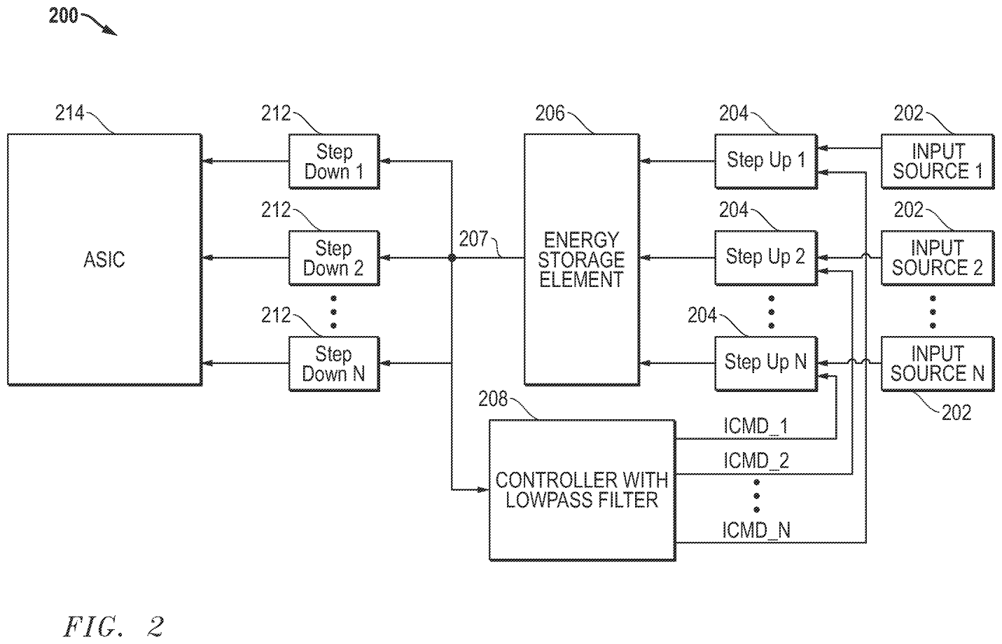

FIG. 2 illustrates in block diagram form a peripheral data processor 200 including a power supply circuit for handling power from multiple external voltage sources according to some embodiments. Peripheral data processor 200 may be a PCIe card or module, or another suitable type of peripheral computing modules, such as an open compute project (OCP) acceleration module (OAM). Peripheral data processor 200 includes a number of power supply inputs 202, a step up converter 204, an energy storage element 206, an intermediate voltage bus 207, a power supply controller 208, a number of step down converters 212, and an application-specific integrated circuit (ASIC) 214. FIG. 2 shows only the ASIC and power supply circuit components of peripheral data processor 200, and omits common elements such as the bus controller and input/output circuitry. The depicted power supply generally provides separate voltage supplies to multiple subsystems of ASIC 214 by merging the fragmented PCIe inputs onto intermediate voltage bus 207, and then stepping down the voltage from intermediate voltage bus 207 to create a supply voltage for each of the subsystems.

Each of power supply inputs 202 receives a supply voltage from a different voltage source, as indicated by the labels “SOURCE1”, “SOURCE2”, and “SOURCEN”. In the embodiments of FIG. 1, for example, the different sources are two separate voltage supply rails of peripheral bus 120, and two separate external voltage supplies from power supply unit 210. Other embodiments can use fewer or more separate voltage sources. Each power supply input is connected to an input of a respective step up converter 204.

Each of step up converters 204 has an input connected to a respective one of power supply inputs 202, a current control input, and an output connected to energy storage element 206. Each step up converter 204 receives a supply voltage from its power supply input 202, steps up the voltages to a higher voltage level, and provides a resulting single supply voltage at an output connected to energy storage element 206.

Energy storage element 206 has a number of inputs receiving the supply voltage from each respective step up converter 204, and an output connected to intermediate voltage bus 207. In embodiments in which energy storage element 206 is implemented with capacitors, the input and output terminals can be the same terminal. Intermediate voltage bus 207 is connected to step down converters 212.

Each of step down converters 212 has an input connected to intermediate voltage bus 207 and an output connected to a respective power supply input of ASIC 214 for supplying a designated subsystem of ASIC 214 with power. Step down converters 212 may be implemented with any suitable DC to DC step down converter topology such as a buck converter or a switched capacitor converter, for example.

Power supply controller 208 has an input connected to intermediate voltage bus 207 for monitoring the voltage thereon, and a number of outputs connected to respective current command inputs for each of step up converters 204 labelled “ICMD_1”, “ICMD_2”, through “ICMD_N”.

In operation, power supply controller 208 monitors the voltage level on intermediate voltage bus 207 and, responsive to the voltage level dropping below a designated level, commands step up converters 204 to increase the current supplied through the step up conversion process and provided to intermediate voltage bus 207. Responsive to the voltage level rising above a designated level, power supply controller 208 commands the step up converters 204 to decrease the current they supply. Such a scheme allows far more efficient use of the power capacity of each external power supply as compared to supplying individual subsystems of the peripheral data processor with individual external power supplies. For example, frequently prior art peripheral data processors such as graphics cards which use the individual connection method are only able to employ around 70% of the power capacity of the external power supplies due to mismatches in the power required by individual subsystems to the respective capacities of the individual power supplies coupled thereto. Use of the techniques herein, in the various embodiments provided, is able to increase the use of power up to near 100% of the available capacity of the external power supplies. This improvement allows for substantial increases in computing capacity using the same combination of bus supplies and external supplies. It also allows for increased variability in the configurations of single or multiple peripheral data processors because each peripheral data processor is able to use more of the available power. Furthermore, this improvement allows for use of higher power peripheral data processors, in many cases, than would be possible with a given combination of bus supplies and external power supplies.

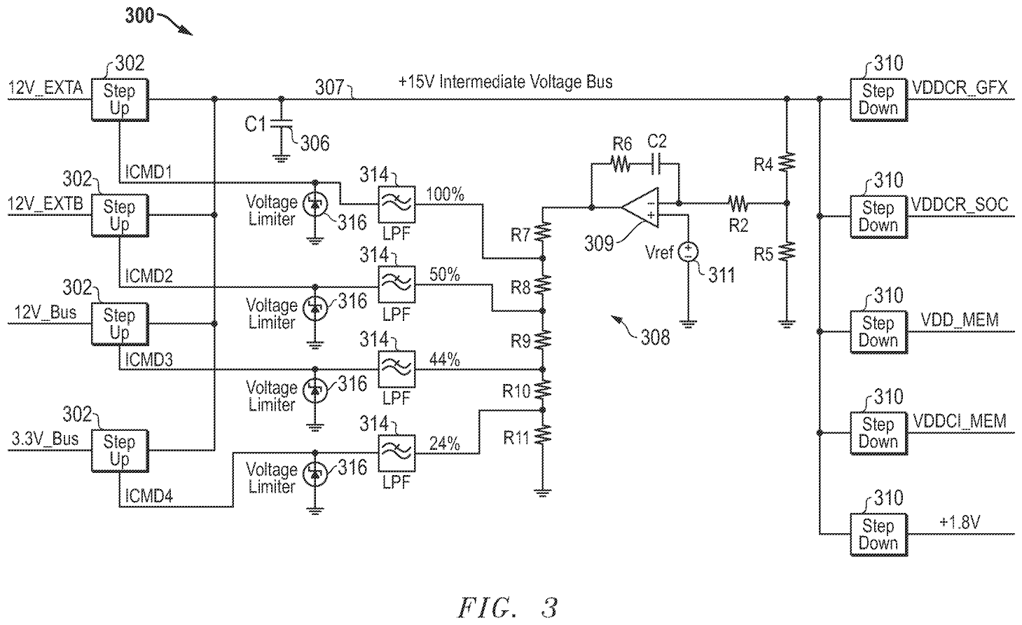

FIG. 3 shows in circuit diagram form a power supply circuit 300 for supplying power from multiple peripheral power supplies to a peripheral data processor according to some embodiments. Power supply circuit 300 is one possible implementation of power supply circuit for peripheral data processor 200 of FIG. 1. Power supply circuit 300 includes four supply voltage inputs labelled “12V_EXTA”, “12V_EXTB”, “12V_Bus”, and “3.3V_Bus”, four step up converters 302, a capacitor 306, an intermediate voltage bus 307, a power supply control circuit 308, five step down converters 310, and five voltage supply outputs labelled “VDDCR_GFX”, “VDDCR_SOC”, VDD_MEM”, “VDDCI_MEM”, and “1.8V”.

Voltage supply inputs 12V_EXTA and 12V_EXTB are for connecting to external supply voltages from a power supply unit such as power supply unit 210 (FIG. 1), and in this embodiment each receives a 12V external supply voltage. Voltage supply inputs 12V_Bus and 3.3V_Bus are connected to different power supply rails of a peripheral bus such as peripheral bus 120, and receive a 12V bus supply voltage and a 3.3V bus supply voltage, respectively.

Each step up converter 302 has an input receiving a supply voltage from a respective one of the voltage supply inputs, a current control input labelled, respectively, “ICMD1”, “ICMD2”, “ICMD3”, and “ICMD4”, and an output connected to capacitor 306, intermediate voltage bus 307. In this embodiment, three of step up converters 302 receive a 12V input and one receives a 3.3V input, and all produce a 15V output provided to intermediate voltage bus 307 and capacitor 306. Step up converters 302 are controlled-current converters which provide a designated output voltage and supply a current at that voltage controlled by their current command input.

Capacitor 306 serves as an energy storage element to smooth the voltage level of intermediate voltage bus 307 during transient spikes in power demand, and has a first terminal connected to intermediate voltage bus 307 and a second terminal connected to the system ground of the peripheral data processor. Intermediate voltage bus 307 is connected to outputs of each step up converter 302, the positive terminal of capacitor 306, and the inputs of each step down converter 310.

Each of step down converters 310 steps down its input voltage from the common voltage level on intermediate voltage bus 307 to a desired load supply level to supply a sub-system of a GPU of the peripheral data processor. The load supply voltages produced by step down converters 310 can be set to different levels depending on the voltage requirements of the GPU. In this embodiment, the supplied voltages are a graphics core supply voltage “VDDCR_GFX”, a system-on-chip supply voltage “VDDCR_SOC”, a memory supply voltage VDD_MEM”, a memory supply voltage “VDDCI_MEM”, and digital logic supply voltage “1.8V”.

Power supply control circuit 308 includes a voltage divider formed by a resistor R4 and a resistor R5, a resistor R2, an operational amplifier (“op amp”) 309, a reference voltage generator 311, a resistor R6, a capacitor C2, a voltage divider formed by resistors R7, R8, R9, R10, and R11, a number of lowpass filters 314, and a number of voltage limiters 316.

The input terminal of power supply control circuit 308 is connected to intermediate voltage bus 307 at a terminal of resistor R4. Resistor R5 is connected between the other terminal of resistor R4 and ground. Resistors R4 and R5 function as a voltage divider to provide a voltage of a fixed proportion to the voltage on intermediate voltage bus 307. Resistor R2 is has a first terminal connected to the intermediate node between resistors R4 and R5, and a second terminal connected to the negative input of op amp 309. Capacitor C2 and resistor R6 are connected in series between the negative input of op amp 309 and the output of op amp 309. Reference voltage generator 311 has an output connected to the positive input terminal of op amp 309, and generates a voltage “Vref” provided to the positive input terminal of op amp 309.

Resistors R7, R8, R9, R10, and R11 are connected in series between the output terminal of op amp 309 and ground. As this series voltage divider is driven by the output of op amp 309, a current control signal ICMD1 is produced at the second terminal of resistor R7, fed to one of lowpass filters 314, and then fed to one of step up converters 302. Similarly, current control signals ICMD2, ICMD3, and ICMD4 are produced at the negative terminals of resistors R8, R9, and R10, low pass filtered, and fed to the other step up converters 302, respectively. Voltage limiters 316 provide an upper limit to the level of current control signals, and are selected with a voltage limit level to provide protection from excessive input current to intermediate voltage bus 307.

In operation, step up converters 302 step up the voltages from the various supply inputs to a common voltage level (in this example, 15V) used on intermediate voltage bus 307 and couple the resulting voltage onto the intermediate voltage bus 307. Step down converters 310 convert the common voltage from the intermediate voltage bus to a plurality of load supply voltages and supply the load supply voltages to respective subsystems of the peripheral data processor. Power supply control circuit 308 monitors the voltage common voltage on intermediate voltage bus 307 and produces current control signals to control step up converters 302. In this embodiment, power supply control circuit 308 serves as a feedback amplifier that increases the current at the output of op amp 309 responsive to a drop in the common voltage causing the voltage at the negative terminal of op amp 309 to drop. This increased output current produces larger voltages for current control signals ICMD2, ICMD2, ICMD3, and ICMD4, causing step up converts 302 to increase their output current to stabilize the common voltage on intermediate voltage bus 307. As the common voltage rises again, op amp 309 reduces the current on its at its output and the current control signals drop again.

In some embodiments, resistors R7, R8, R9, R10, and R11 are implemented as programmable resistors, which allows power supply circuit 300 to be reconfigured to draw a different proportion of current from each external power supply. Such programmable resistors are preferably controlled by register values in the peripheral data processor, which are configurable through firmware of the peripheral data processor. This arrangement has the advantage of allowing power supply circuit 300 to be adapted both to differing power capacities among the external power supplies, and differing total power requirements among subsystems of the peripheral data processor. Such adjustments are made without any redesign of the circuit board or circuit module implementing the peripheral data processor, and without any change of components therein.

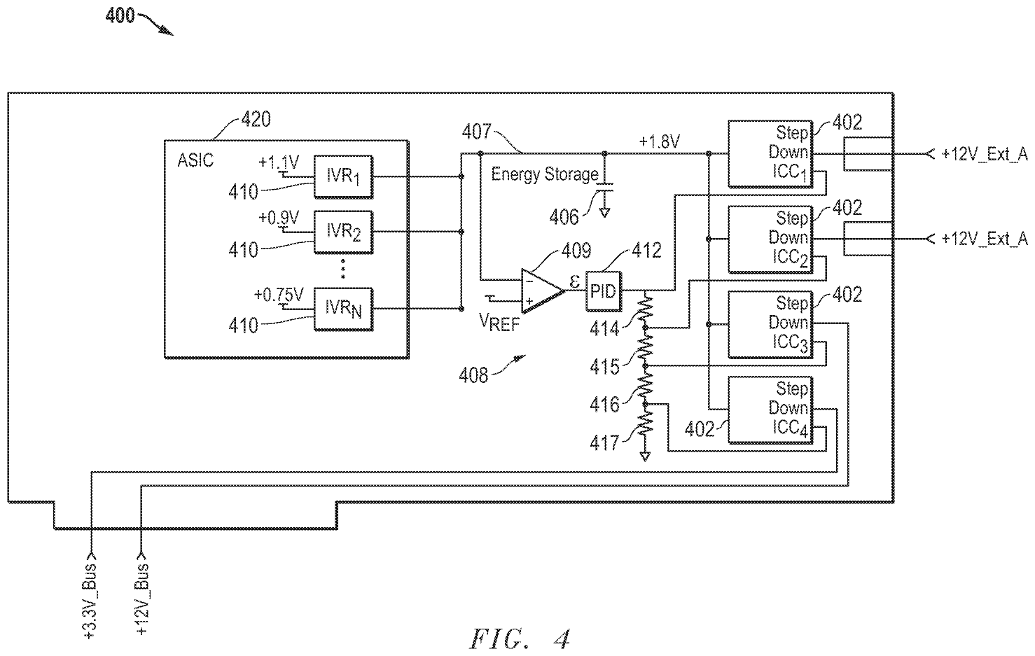

FIG. 4 illustrates in mixed block diagram and circuit diagram form a power supply circuit 400 for a peripheral data processor according to other embodiments. As depicted, bus supply voltages and external supply voltages are stepped down to a common voltage level on an intermediate voltage bus, and then stepped down again to produce individual supply voltages for the subsystems of an ASIC by Integrated Voltage Regulators (IVR's) in the ASIC.

Power supply circuit 400 includes four supply voltage inputs labelled “+12V_EXTA”, “+12V_EXTB”, “+12V_Bus”, and “+3.3V_Bus”, four step down converters 402, a capacitor 406, an intermediate voltage bus 407, a power supply control circuit 408, and a number of IVRs 410 (“step down IVRs”) that are integrated with an ASIC 420.

Voltage supply inputs +12V_EXTA and +12V_EXTB are for connecting to external supply voltages from a power supply unit such as power supply unit 210 (FIG. 1), and in this embodiment each receive a 12V external supply voltage. Voltage supply inputs +12V_Bus and +3.3V_Bus are connected to different power supply rails of a peripheral bus such as peripheral bus 120, and receive a 12V bus supply voltage and a 3.3V bus supply voltage, respectively.

Each step down converter 402 has an input receiving a supply voltage from a respective one of the voltage supply inputs, a current control input labelled, respectively, “ICC₁”. “ICC₂”, “ICC₃”, and “ICC₄”, and an output connected to capacitor 406, intermediate voltage bus 407. In this embodiment, three of step down converters 402 receive a 12V input and one receives a 3.3V input, and all produce a 1.8V output provided to intermediate voltage bus 407 and capacitor 406. Step down converters 402 are current controlled converters which provide a designated output voltage and supply a current at that designated voltage controlled by their current command input.

Capacitor 406 serves as an energy storage element to smooth the voltage level of intermediate voltage bus 407, and has a negative terminal connected to the system ground of the peripheral data processor and a positive terminal connected to intermediate voltage bus 407. Intermediate voltage bus 407 is connected to outputs of each step down converter 402, the positive terminal of capacitor 406, and the inputs of each step down IVR 410.

ASIC 420 may be an APU, a GPU, or other data processor such as an artificial intelligence processor, with multiple subsystems that require separate power supply voltages, such as one or more processor cores, an input/output subsystem, a memory interface subsystem, and a data fabric subsystem. Step down IVRs 410 are integrated into ASIC 420, either partially (with active devices the step down converters on board ASIC 420 and selected passive devices such as capacitors external to ASIC 420), or completely integrated (with all devices integrated into ASIC 420).

In operation, each of step down IVRs 410 steps down its input voltage from the common voltage level on intermediate voltage bus 407 to a desired load supply level to supply a respective sub-system of ASIC 420. The load supply voltages produced by step down IVRs 410 can be set to different levels depending on the voltage requirements of ASIC 420. As examples, depicted are a 1.1V supply, a 0.9V supply, and a 0.75V supply produced by step down converters labelled “IVR₁”, “IVR₂” to “IVR_{N}” to indicate that more step down converters may be employed.

Power supply control circuit 408 includes an op amp comparator 409, a proportional-integral-derivative (PID) controller 412, and a voltage divider formed by resistors 414, 415, 416, and 417. Op amp comparator 409 has a negative input terminal connected to intermediate voltage bus 407, a positive input receiving a reference voltage “Vref”, and an output terminal. PID controller 412 has an input connected to the output terminal of Op amp comparator 409 receiving an error signal labelled “ [symbol] ”, and an output connected to a positive terminal of resistor 414 and to the current control input ICC₁ of one of step down converters 402. Resistors 414, 415, 416, and 417 are connected in series between the output of PID controller 412 and ground, producing a number of current control signals fed to step down converters 402 which command the current delivered by each respective step down converter.

In operation, step down converters 402 step down the voltages from the various supply inputs to a common voltage level used on intermediate voltage bus 407 and couple the resulting lower voltage onto the intermediate voltage bus 407. Step down IVRs 410 convert the common voltage from the intermediate voltage bus to a plurality of load supply voltages and supply the load supply voltages to respective subsystems of the peripheral data processor. Power supply control circuit 408 monitors the voltage common voltage on intermediate voltage bus 407 and produces current control signals to control step down converters 402. In this embodiment, power supply control circuit 408 employs proportional-integral-derivative control with PID controller 412, based on the error signal [symbol] . The output of PID controller 412 is a voltage produced by summing a proportional term “P” based on the magnitude of [symbol] , an integral term “I” based on the integral of [symbol] , and a derivative term “D” based on the derivative of [symbol] . Such a control serves to increase or decrease the current provided by step down converters 402 to produce a constant value for the common voltage on intermediate voltage bus 407 while reducing oscillations caused by sudden changes in the power demanded by various the various subsystems of ASIC 420. If the common voltage drops, the output of PID controller 412 increases in voltage, producing larger voltages for current control signals fed to the current control inputs ICC₁, ICC₂, ICC₃, and ICC₄, respectively, causing step up converts 402 to increase their output current to stabilize the common voltage on intermediate voltage bus 407. As the common voltage rises again, the output of PID controller 412 alters the summed control terms accordingly and the current control signals drop again.

As can be understood, these techniques have similar advantages to the step-up, step-down arrangement described with respect to FIG. 2 and FIG. 3. Power supply circuit 400 is reconfigurable to meet any combination of peripheral data processor subsystem power requirements that are within the total capacity of all the external power supplies combined, without redesigning the power supply circuit 400.

In some embodiments, resistors 414, 415, 416, and 417 are implemented as programmable resistors, which provides even more flexibility to work with different combinations of external power supplies, similarly to the advantages discussed with respect to FIG. 3.

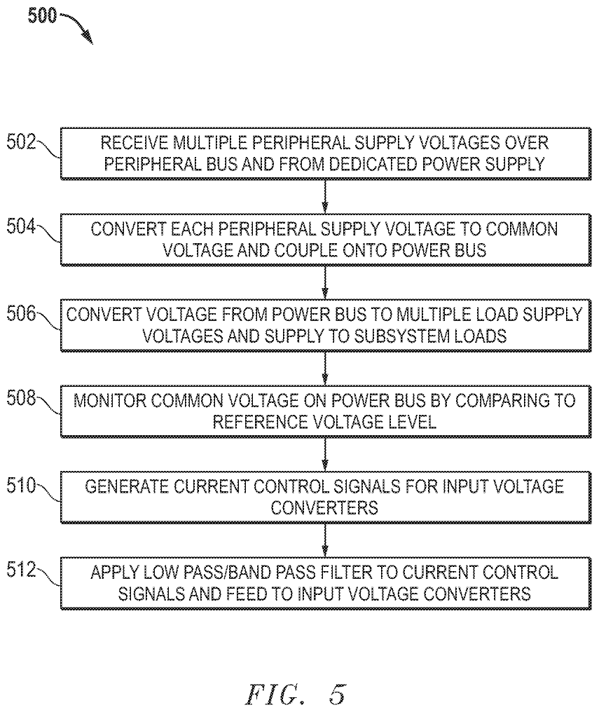

FIG. 5 shows a flow diagram 500 of a process for providing power to multiple subsystems of a peripheral data processor according to some embodiments. The process begins at block 502 where it receives multiple peripheral supply voltages, both from a peripheral bus and from a dedicated external power supply providing multiple supply voltages. At block 504, the process converts each of the peripheral supply voltages to a common voltage and couples the converted voltages onto a common power bus, such as the intermediate voltage busses described above.

At block 506, the process converts the voltage from the common power bus to multiple load supply voltages and supplies those voltages to subsystem loads of a peripheral data processor.

At block 508, the process monitors the common voltage on the common power bus by comparing it to a reference voltage level. Based on this monitoring, the process at block 510 generates current control signals for the input voltage converters employed to perform block 504. Optionally, at block 512, the process applies a low pass or band pass filter to the current control signals to limit high frequency noise, and feeds the resulting signals to control the input voltage converters. Also optionally, at block 512, the process applies a voltage limiter such as voltage limiters 316 (FIG. 3), which serves to limit the level of the current control signals to provide over-current protection.

While particular embodiments have been described, various modifications to these embodiments will be apparent to those skilled in the art. For example, the internal architecture of the peripheral data processor may vary in different embodiments. Various types of peripheral busses may be used. The power supply controller and input voltage converters of the various embodiments may be integrated into a module or special purpose chip, or some combination of discrete devices and integrated chips. Accordingly, it is intended by the appended claims to cover all modifications of the disclosed embodiments that fall within the scope of the disclosed embodiments.

What is claimed is:

1. A power supply circuit for supplying power from multiple peripheral power supplies to a data processor, comprising:
a power bus;
a plurality of load voltage converters each including an input coupled to the power bus and an output coupled to a respective one of multiple subsystems of the data processor;
a plurality of input voltage converters each including an input for coupling to a respective one of multiple peripheral power supply voltages and an output coupled to the power bus; and
a feedback control circuit including an input coupled to the power bus and a plurality of outputs coupled to respective ones of the input voltage converters for controlling a current draw of the respective input voltage converter.

2. The power supply circuit of claim 1, wherein the input voltage converters include at least a first converter for coupling to a first peripheral power supply voltage provided over a peripheral bus, a second step up converter for coupling to a second peripheral power supply voltage, lower than the first peripheral power supply voltage, supplied over the peripheral bus, and a third voltage converter for coupling to a secondary voltage supply providing a third peripheral power supply voltage.

3. The power supply circuit of claim 1, wherein the load voltage converters include at least a first step down voltage converter supplying a first subsystem of the data processor, and a second step down voltage converter supplying a second subsystem of the data processor.

4. The power supply circuit of claim 1, wherein the feedback control circuit comprises:
a reference voltage circuit providing a reference voltage at a desired voltage level relative to a target voltage of the power bus; and
a comparator circuit comparing a voltage derived from common supply bus to the reference voltage; and
a signal generating circuit generating a plurality of current control signals provided at respective ones of the outputs of the feedback control circuit.

5. The power supply circuit of claim 4, wherein the signal generating circuit includes a plurality of resistors arranged in series.

6. The power supply circuit of claim 5, wherein the plurality of resistors are programmable resistors.

7. The power supply circuit of claim 4, further comprising a plurality of filters coupled between respective outputs of the feedback control circuit and respective ones of the input voltage converters.

8. The power supply circuit of claim 1, wherein the plurality of load voltage converters are integrated voltage regulators of an integrated circuit.

9. A method of providing power to multiple subsystems of a data processor, the method comprising:
receiving a plurality of peripheral power supply voltages;
converting the peripheral power supply voltages to a common voltage and coupling power from said converted peripheral power supply voltages onto a power bus;
converting the common voltage from the power bus to a plurality of load supply voltages and supplying said load supply voltages to respective subsystems of the computing module; and
responsive to monitoring the common voltage on the power bus, controlling current drawn from each of the peripheral power supply voltages.

10. The method of claim 9, wherein the peripheral power supply voltages include at least a first peripheral power supply voltage provided over a peripheral bus, a second peripheral power supply voltage, lower than the first peripheral power supply voltage, supplied over the peripheral bus, and a third peripheral power supply voltage provided directly from a voltage supply external to the computing module.

11. The method of claim 9, wherein the computing module is a graphics data processor, and wherein supplying said load supply voltages to respective subsystems of the computing module further comprises supplying a first subsystem of the graphics data processor with a first load supply voltage lower than the common voltage and supplying a second subsystem of the graphics data processor with a second load voltage supply different from the first load voltage supply.

12. The method of claim 9, wherein:
monitoring the common voltage on the power bus further comprises comparing the common voltage to a reference voltage level; and
controlling current drawn from each of the peripheral power supply voltages further comprises generating a plurality of current control signals and providing said current control signals to respective input voltage converters receiving respective ones of the peripheral power supply voltages.

13. A computing system comprising:
a peripheral bus carrying communication signals and first and second peripheral power supply voltages,
a secondary power supply providing a third peripheral power supply voltage;
a data processor coupled to the peripheral bus and the secondary power supply, the data processor comprising multiple subsystems and a power supply circuit, the power supply circuit comprising:
a power bus;
a plurality of load voltage converters each including an input coupled to the power bus and an output coupled to a respective one of multiple subsystems;
a plurality of input voltage converters each including an input for coupling to a respective one of the peripheral power supply voltages and an output coupled to the power bus; and
a feedback control circuit including an input coupled to the power bus and a plurality of outputs coupled to respective ones of the input voltage converters and controlling a current draw of the respective input voltage converter.

14. The computing system of claim 13, wherein the input voltage converters include at least a first converter for coupling to a first peripheral power supply voltage provided over a peripheral bus, a second step up converter for coupling to a second peripheral power supply voltage, lower than the first peripheral power supply voltage, supplied over the peripheral bus, and a third voltage converter for coupling to the secondary power supply.

15. The computing system of claim 13, wherein the load voltage converters include at least a first step down voltage converter supplying a first subsystem of the data processor, and a second step down voltage converter supplying a second subsystem of the data processor.

16. The computing system of claim 13, wherein the feedback control circuit comprises:
a reference voltage circuit providing a reference voltage at a desired voltage level relative to a target voltage of the power bus; and
a comparator circuit comparing a voltage derived from common supply bus to the reference voltage; and
a signal generating circuit generating a plurality of current control signals provided at respective ones of the outputs of the feedback control circuit.

17. The computing system of claim 16, wherein the signal generating circuit includes a plurality of resistors arranged in series.

18. The computing system of claim 17, wherein the plurality of resistors are programmable resistors.

19. The computing system of claim 16, further comprising a plurality of filters coupled between respective outputs of the feedback control circuit and respective ones of the input voltage converters.

20. The computing system of claim 13, wherein the data processor embodied in one of a graphics card and an open compute project (OCP) acceleration module (OAM).
